(19) United States
(12) Patent Application Publication
(10) Pub. No.: US 2007/0256300 A1
(43) Pub. Date: Nov. 8, 2007

(54) Method and Device for Machining Cracking Groove for Connecting Rod

(76) Inventors: Hideki Okumura, Koga-shi (JP); Tsuguo Koguchi, Nasukarasuyama-shi (JP)

Correspondence Address: BIRCH STEWART KOLASCH & BIRCH, PO BOX 747, FALLS CHURCH, VA, 22040-0747, US

(21) Appl. No.: 11/662,609

(22) PCT Filed: Nov. 22, 2005
(86) PCT No.: PCT/JP05/21488

§ 371 Date: Mar. 13, 2007

(30) Foreign Application Priority Data
Nov. 25, 2004 (JP) 2004-341271
Nov. 25, 2004 (JP) 2004-341272

(51) Int. Cl. B23P 13/00

(52) U.S. Cl. 29/888.09; 409/235

(57) ABSTRACT

A method and a device for machining a cracking groove for a connecting rod, wherein a drive pulley is rotated under the driving action of a rotatingly driving source installed in a body to transmit the rotatingly driving force of the drive pulley to a driven pulley through a drive force transmission belt so as to rotate a groove machining part integrally connected to the driven pulley. In the groove machining part, a spindle integrally connected to the driven pulley is rotatably supported on a support part, and a saw having a plurality of blade parts on the outer peripheral surface thereof is installed on the holding part of the spindle. A first groove of roughly V-shape in cross section is formed in the large end hole of a connecting rod by inserting the metal saw into the large end hole of the connecting rod, and a second groove of roughly V-shape in cross section which is symmetrical with the first groove is formed in the connecting rod at a position opposed to the first groove with respect to the axis of the connecting rod.

### TECHNICAL FIELD

The present invention relates to a method of and an apparatus (device) for machining cracking grooves in an inner surface of a larger end hole defined in a connecting rod for use in a vehicular engine, after the connecting rod has been integrally formed, wherein the cracking grooves are then used to fracture the connecting rod into a cap part and a rod part.

### BACKGROUND ART

Vehicular engines have a crankshaft, which is operatively coupled to pistons by connecting rods, for transmitting rotational drive power from the crankshaft to the pistons.

Each of the connecting rods has a larger end hole defined in a larger end portion thereof, wherein a journal of the crankshaft is rotatably supported in the larger end hole by means of a bearing that is mounted in the larger end hole. The connecting rod also has a smaller end hole defined in a smaller end portion thereof. A piston pin extending through the piston is inserted and supported in the smaller end hole by means of another bearing.

The connecting rod is generally formed by forging. Two processes are known for forming the connecting rod. According to one process, a shank (rod part), serving as a main connecting rod body, and a cap part are separately produced. According to the other process, which is known as a cracking process, a one-piece connecting rod is produced and then fractured into a shank (rod part) and a cap part.

During the cracking process, for fracturing the one-piece connecting rod into the shank and the cap part, a pair of cracking grooves is formed at the boundary between the shank and the cap part along the inner surface of a larger end hole, which is formed in the larger end portion of the connecting rod. The grooves are formed to a predetermined depth by broaching with a cutting tool, or by laser beam machining, when or after the one-piece connecting rod is produced.

A machining apparatus for machining a connecting rod according to such a cracking process has broach teeth disposed on an outer circumferential surface of a jig along an axial direction thereof. The jig is inserted into the larger end hole of the connecting rod, and is displaced while the broaching edges are held against the inner circumferential surface of the larger end hole, thereby forming broached grooves on the inner circumferential surface of the larger end hole along the axial direction thereof (see, for example, Japanese Patent No. 3012510).

### DISCLOSURE OF THE INVENTION

### Problems to be Solved by the Invention

For broaching the larger end hole of the connecting rod using the machining apparatus disclosed in Japanese Patent No. 3012510, the positions and depths of the cracking grooves, which are formed on the inner circumferential surface of the larger end hole, are required to be substantially uniform. Stated otherwise, the grooves defined in the larger end hole are required to be in a symmetrical relation with respect to each other, in order to fracture the connecting rod uniformly and smoothly into a shank and a cap part.

The broach teeth of the jig used to broach a cracking groove have a substantially V-shaped cross section. Therefore, the cracking grooves that are formed by the jig also are of a substantially V-shaped cross section. However, since it is difficult for the broach teeth of the jig to form cracking grooves of a substantially V-shaped cross section so as to have a sharp angle, it is necessary to apply a large impact load to separate the connecting rod into the shank and the cap part from the cracking groove, and therefore it is difficult to fracture the connecting rod reliably and uniformly into the shank and the cap part.

According to a machining process that uses throwaway tips, the inner circumferential surface of the larger end hole of the connecting rod is intermittently cut by means of such throwaway tips. Therefore, the apexes of the cutting edges of the throwaway tips become worn. When a groove is machined, it is difficult for the throwaway tips to produce a sharp groove angle, thus tending to lower stress concentration at the time of cracking the connecting rod.

If a cracking groove is formed by laser beam machining, then a machining apparatus must be used, which is large in size, wherein the installation costs required for such a machining apparatus are high.

It is a general object of the present invention to provide a machining apparatus for machining a pair of cracking grooves on the inner circumferential surface of the larger end hole of a connecting rod, reliably and at low cost.

A major object of the present invention is to provide a machining method of machining a pair of cracking grooves, which have an optimized groove shape for promoting fracture, on the inner circumferential surface of the larger end hole of a connecting rod.

### BRIEF DESCRIPTION OF THE DRAWINGS

FIG. 1 is a fragmentary perspective view of a machining apparatus for machining cracking grooves in a connecting rod, according to an embodiment of the present invention;

FIG. 2 is a vertical cross-sectional view of the machining apparatus shown in FIG. 1;

FIG. 3 is an exploded perspective view, partly in cross section, showing a metal saw, a spacer, and a fastening nut, which are released from a spindle of a groove machining unit shown in FIG. 2;

FIG. 4 is a vertical cross-sectional view of the machining apparatus shown in FIG. 2;

FIG. 5 is a horizontal cross-sectional view of the groove machining unit of the machining apparatus shown in FIG. 2;

FIG. 6 is a vertical cross-sectional view, with certain parts omitted from illustration, showing the manner in which the groove machining unit is inserted into the larger end hole of a connecting rod, for machining a first groove in one side of the inner circumferential surface of the larger end hole;

FIG. 7 is a vertical cross-sectional view, with certain parts omitted from illustration, showing the manner in which the groove machining unit is displaced downwardly through the larger end hole, after having formed the first groove in the larger end hole;

FIG. 8 is a vertical cross-sectional view, with certain parts omitted from illustration, showing the manner in which the groove machining unit is displaced into the larger end hole from below, for machining a second groove at a position that is in symmetrical relation to the first groove, in the inner circumferential surface of the larger end hole;

FIG. 9 is an enlarged plan view of a region disposed near the first groove or the second groove, formed by the groove machining unit of the machining apparatus shown in FIG. 5;

FIG. 10A is a perspective view of the connecting rod with first and second grooves formed therein;

FIG. 10B is a perspective view of the connecting rod fractured into a cap part and a rod part;

FIG. 11A is a diagram showing the relationship between an angle of inclination between a pair of tapered surfaces of a cracking groove, and the fracturability of a connecting rod that is fractured from the cracking groove;

FIG. 11B is a diagram showing the relationship between the radius of curvature of an arcuate portion of a cracking groove, and the fracturability of a connecting rod that is fractured from the cracking groove;

FIG. 12 is a plan view, partly omitted from illustration, of a metal saw for cutting a cracking groove;

FIG. 13 is an enlarged fragmentary plan view of the metal saw shown in FIG. 12; and

FIG. 14 is an enlarged plan view showing a modification of the first groove or the second groove formed by the machining apparatus shown in FIG. 5.

### BEST MODE FOR CARRYING OUT THE INVENTION

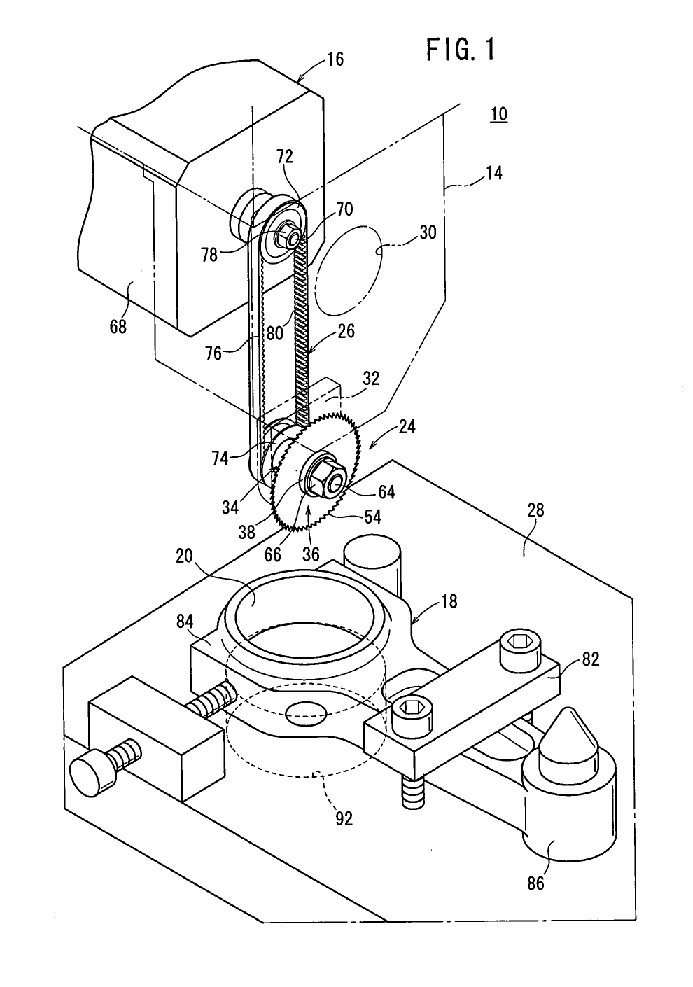

In FIGS. 1 through 4, reference numeral 10 denotes a machining apparatus for machining cracking grooves in a connecting rod (hereinafter referred to simply as “machining apparatus 10”) according to an embodiment of the present invention.

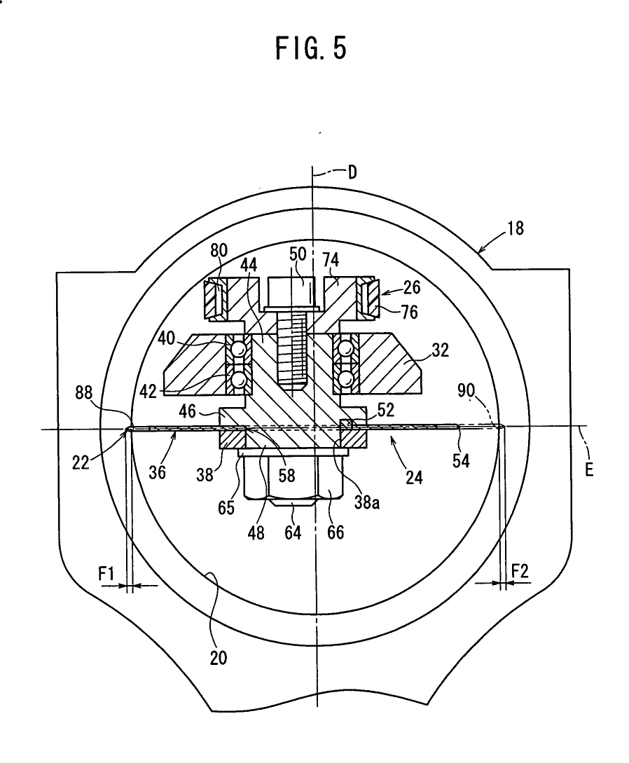

The machining apparatus 10 comprises a body 14 coupled by bolts or the like, not shown, to the end of an industrial articulated robot 12 (e.g., a numerically controlled machine), a drive unit 16 coupled to the body 14 and having a rotary drive source (to be described later) controlled by a control signal (electric signal) output from a driver, not shown, a groove machining unit 24 coupled to the lower end of the body 14 for forming a cracking groove 22 (see FIG. 5) on an inner circumferential surface of a larger end hole 20 of a connecting rod 18, and a drive force transmitting mechanism 26 for transmitting a rotational drive force from the drive unit 16 to the groove machining unit 24.

The connecting rod 18 is placed on a mount base 28 disposed below the machining apparatus 10.

The robot 12 operates to move the machining apparatus 10, which is firmly coupled to the robot 12, to any position in three axes X, Y, Z so as to orient the machining apparatus 10 in any desired direction.

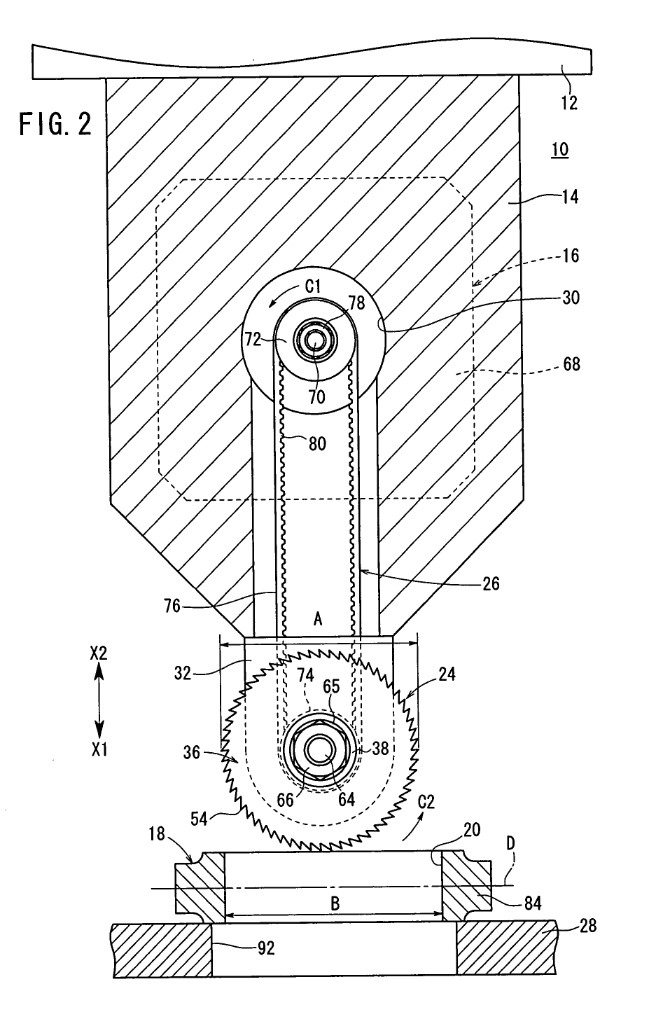

As shown in FIGS. 2 through 4, the body 14 has an opening 30 defined substantially centrally therein at a position confronting a drive pulley 72 (to be described later) disposed in the body 14. The opening 30, which is essentially circular in shape, is greater in diameter than the drive pulley 72, so that the drive pulley 72 can be taken out of the body 14 through the opening 30.

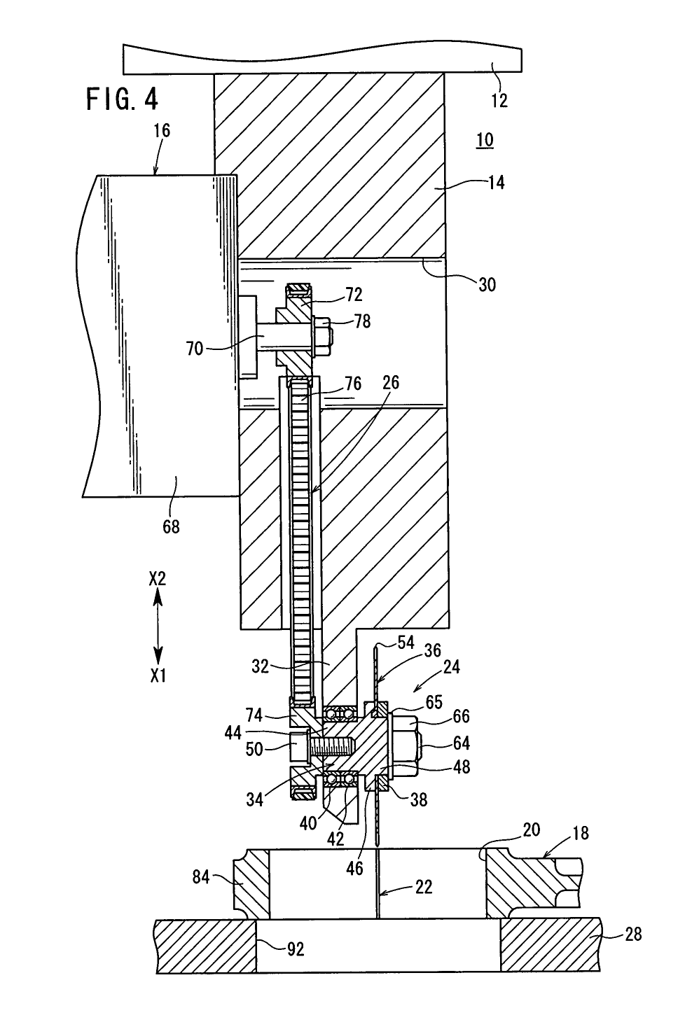

The groove machining unit 24 is rotatably supported by a support 32 (see FIG. 4), which is mounted on and projects from a lower surface of the body 14.

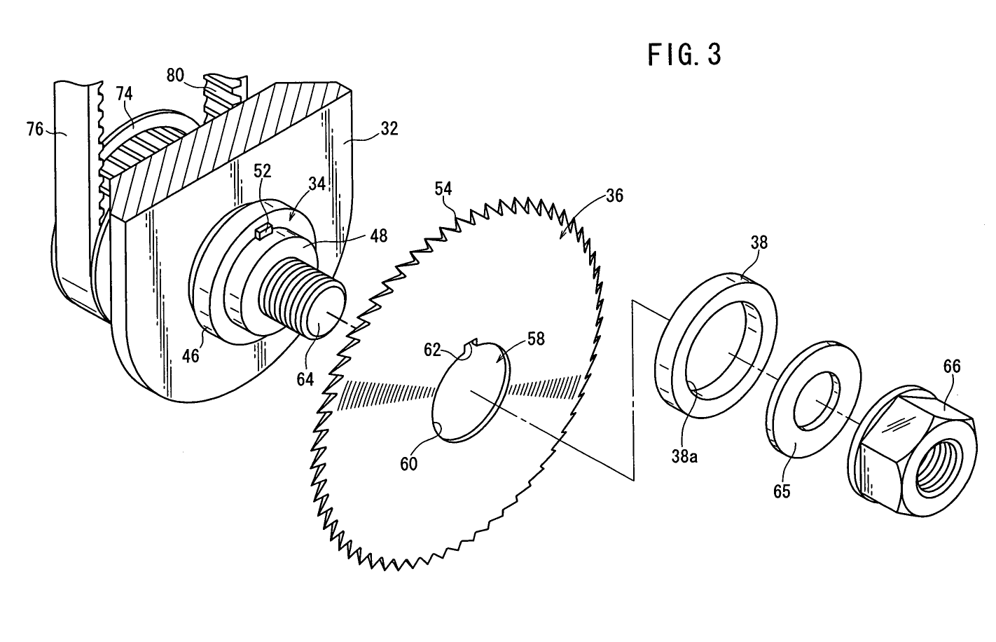

As shown in FIGS. 3 and 4, the groove machining unit 24 comprises a spindle (rotational shaft) 34 rotatably held by the support 32, a metal saw 36 fitted over the spindle 34 for rotation in unison therewith, and a spacer 38 sandwiching the metal saw 36 against the spindle 34.

As shown in FIG. 4, the spindle 34 comprises a shaft 44 rotatably held by first and second bearings 40, 42 disposed in the support 32, a flange 46 extending radially outwardly from the shaft 44, and a holder 48, which is smaller in diameter than the flange 46, and which holds the metal saw 36 thereon.

A driven pulley 74, to be described later, of the drive force transmitting mechanism 26 is firmly coupled to an end of the shaft 44 by a support bolt 50.

As shown in FIG. 3, a key 52 having a substantially rectangular cross section is mounted in a mount groove within the flange 46. The key 52 projects a predetermined distance from an end face of the flange 46 toward the holder 48, and also projects radially outwardly from the outer circumferential surface of the holder 48.

The metal saw 36 is in the form of a thin disk made of a metal material and has a plurality of successive serrated cutting teeth 54 spaced at equal intervals on the outer circumferential edge thereof. A double angle milling cutter, with cutting teeth 54 disposed at substantially equal angular intervals along its peripheral edge, is suitable for use as the metal saw 36. Alternatively, a milling cutter, not shown, may be used as a substitute for the metal saw 36.

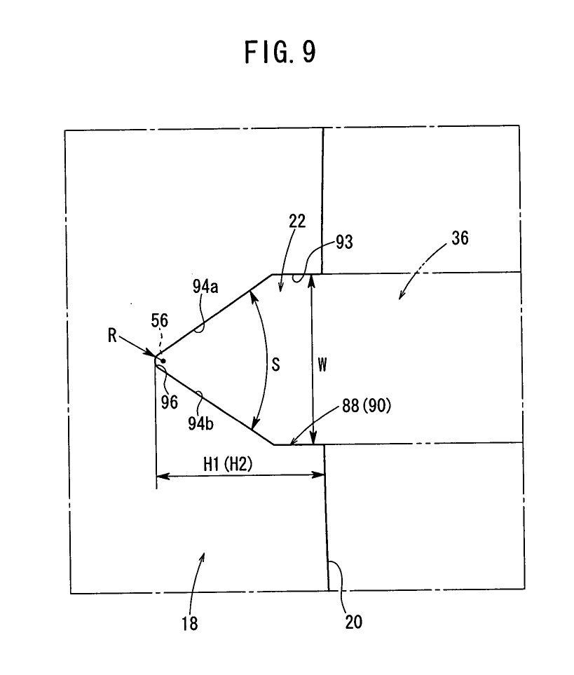

As shown in FIG. 9, the cross-sectional shape of each of the cutting teeth 54 of the metal saw 36 is tapered radially outwardly at a sharp angle, and has an arcuate round (R) portion 56 having a predetermined radius at its tip. The metal saw 36 employed in the groove machining unit 24 for machining the cracking groove 22 makes it possible to reduce the radius of curvature of the R portion 56.

The metal saw 36 has an outside diameter greater than that of the flange 46 of the spindle 34 and the spacer 38. As shown in FIG. 2, the outside diameter A of the metal saw 36 is smaller than the diameter B of the larger end hole 20 of the connecting rod 18 (A<B).

As shown in FIG. 3, the metal saw 36 has an insertion hole 58 defined substantially centrally therein, which is to be fitted over the outer circumferential surface of the holder 48 of the spindle 34. The insertion hole 58 has a circular aperture 60 through which the holder 48, which has a cylindrical shape, is to be inserted. Further, a key groove 62 having a substantially rectangular shape extends radially outwardly from the circular aperture 60. When the metal saw 36 is placed on the holder 48, the aperture 60 is fitted over the outer circumferential surface of the holder 48, wherein the key groove 62 receives therein the key 52, which projects radially outwardly from the outer circumferential surface of the holder 48.

When the spindle 34 is rotated by the drive unit 16, since the key 52 of the spindle 34 engages in the key groove 62 of the metal saw 36, the spindle 34 and the metal saw 36 are prevented from being angularly displaced relative to each other. Stated otherwise, since the key 52 engages within the key groove 62, the key 52 functions as a stop for preventing the metal saw 36 from rotating with respect to the spindle 34. Accordingly, when the spindle 34 is rotated by the drive unit 16, the metal saw 36 also is rotated in unison with the spindle 34.

After the metal saw 36 has been mounted on the holder 48, the spacer 38, which has an annular shape, is placed on the holder 48. The spacer 38 has a substantially central hole 38a defined therein, which is fitted over the holder 48.

The spindle 34 also has a boss 64 projecting from an end face of the holder 48 away from the flange 46. The boss 64 has an externally threaded outer circumferential surface, over which a fastening nut 66 is threaded, with a washer 65 interposed between the holder 48 and the fastening nut 66. When the fastening nut 66 is threaded over the boss 64 toward the spacer 38, an inner end face of the fastening nut 66 presses the spacer 38 against the metal saw 36 through the washer 65. Thus, the metal saw 36 is sandwiched between the spacer 38 and the flange 46 and is secured in place. In this condition, the metal saw 36 and the spacer 38 are now firmly fixed to the spindle 34, and can be rotated in unison with the spindle 34 when the spindle 34 is rotated by the drive unit 16.

The drive unit 16 comprises a rotary drive source 68 (e.g., an electric motor) coupled to a substantially central portion of the body 14. When the rotary drive source 68 is supplied with an electric signal from an unillustrated power supply and driver, a drive shaft 70 of the rotary drive source 68 is rotated counterclockwise, in the direction indicated by the arrow C1 (see FIG. 2).

As shown in FIG. 4, the rotary drive source 68 is coupled to a side face of the body 14 where the opening 30 is open, whereby the drive shaft 70 is inserted into the opening 30 of the body 14.

The drive force transmitting mechanism 26 comprises a drive pulley 72 mounted on the drive shaft 70, a driven pulley 74 firmly coupled to the groove machining unit 24, and a drive force transmitting belt 76, such as a timing belt or the like, trained around both the drive pulley 72 and the driven pulley 74.

The drive pulley 72 is securely coupled to the drive shaft 70 by a fastening nut 78 disposed in the opening 30. The drive pulley 72 is rotated in unison with the drive shaft 70 when the rotary drive source 68 is energized. The driven pulley 74 is positioned laterally of the support 32, and is coupled by the support bolt 50 to an end of the shaft 44 of the spindle 34 that is held by the support 32.

As shown in FIG. 2, the drive force transmitting belt 76 is trained around the drive pulley 72 and the driven pulley 74, and extends vertically through the body 14.

The drive force transmitting belt 76 has a plurality of parallel teeth 80 disposed along its inner circumferential surface at spaced intervals. The parallel teeth 80 are held in mesh with both the drive pulley 72 and the driven pulley 74, in order to cause the drive force transmitting belt 76 to move circularly around the drive pulley 72 and the driven pulley 74. When the drive shaft 70 of the rotary drive source 68 is rotated, the drive force of the drive pulley 72 is transmitted through the drive force transmitting belt 76 to the driven pulley 74, which rotates the groove machining unit 24 in unison therewith.

The mount base 28 disposed below the machining apparatus 10 is installed on a floor surface or the like, not shown, and has a substantially horizontal upper surface.

The connecting rod 18 is placed on the upper surface of the mount base 28 such that an axis D (see FIG. 2) of the connecting rod 18 extends substantially in parallel to the upper surface of the mount base 28. The connecting rod 18 has a substantially central portion, which is securely fixed in place by a fixing member 82 (see FIG. 1).

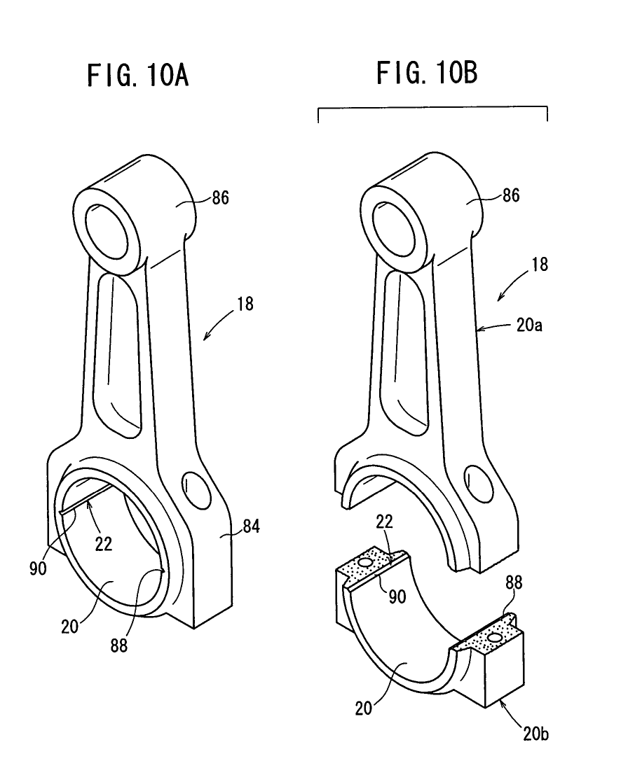

As shown in FIG. 10A, the connecting rod 18 has a larger end portion 84, which is wide on an end thereof, and a smaller end portion 86, which is narrow on the other end thereof. The larger end portion 84 has a larger end hole 20 defined therein for insertion of a crankshaft journal, not shown.

The drive force transmitting mechanism 26 is not limited to the aforementioned features of the drive force transmitting belt 76, the drive pulley 72, and the driven pulley 74. For example, the drive force transmitting mechanism 26 may comprise a first gear (not shown) having a plurality of gear teeth on the drive shaft 70 of the rotary drive source 68, a second gear (not shown) having a plurality of gear teeth on the end of the spindle 34, and wherein a chain is trained around the first gear and the second gear for rotating the spindle 34.

The machining apparatus 10 for forming cracking grooves in a connecting rod according to the embodiment of the present invention is basically constructed as described above. Next, operations and advantages of the machining apparatus 10 shall be described below. As shown in FIG. 1, a state in which the connecting rod 18, in which cracking grooves 22 are to be formed, is fixed to an upper surface of the mount base 28 by the fixing member 82, and wherein the machining apparatus 10 is positioned in a standby mode above the connecting rod 18, is referred to as an initial position.

As shown in FIG. 5, a first cracking groove 88 and a second cracking groove 90 are formed as a pair of cracking grooves, at respective positions where a base line E, which extends substantially perpendicularly to the axis D of the connecting rod 18 and passes through the center of the larger end hole 20, crosses the inner circumferential surface of the larger end hole 20 of the connecting rod 18.

First, it shall be assumed that the smaller end portion 86 of the connecting rod 18 is placed on a lower side of the upper surface of the mount base 28, whereas the larger end portion 84 is placed on an upper side of the mount base 28. For forming the first groove 88 on the inner circumferential surface of the larger end hole 20, which is leftward of the axis D of the connecting rod 18, the machining apparatus 10 that is positioned above the connecting rod 18 is moved under control of the robot 12 in order to position the groove machining unit 24 above the larger end hole 20 of the connecting rod 18. The machining apparatus 10 is moved so that the center of the groove machining unit 24 is offset leftward of the axis D, while the outer circumferential surface of the metal saw 36 overlaps the inner circumferential surface of the larger end hole 20 by an overlapping distance F1, radially outwardly from the larger end hole 20 (see FIG. 5).

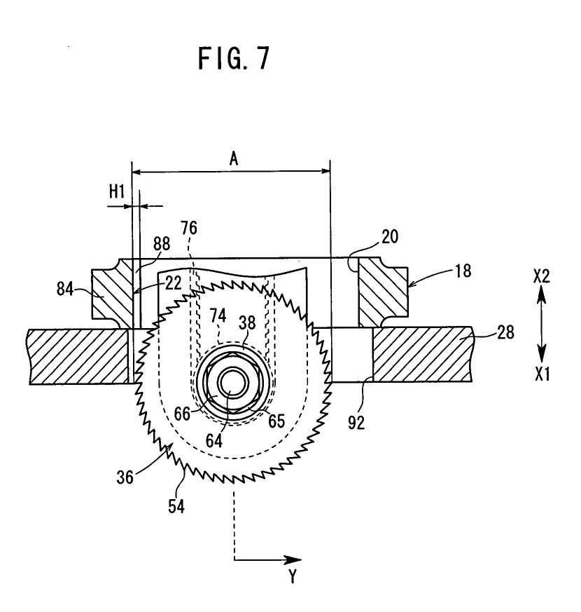

Stated otherwise, the overlapping distance F1, at which the outer circumferential surface of the metal saw 36 overlaps the inner circumferential surface of the larger end hole 20 radially outwardly of the larger end hole 20, represents and determines the depth H1 (see FIG. 7) of the first groove 88, which is formed by the metal saw 36 of the groove machining unit 24 (F1=H1).

Then, as shown in FIG. 2, with the machining apparatus 10 positioned above the larger end hole 20 of the connecting rod 18, the non-illustrated power supply supplies an electric signal to the rotary drive source 68 in order to rotate the drive shaft 70 counterclockwise, in the direction indicated by the arrow C1, thereby rotating the drive pulley 72 counterclockwise in unison with the drive shaft 70. When the drive pulley 72 is rotated, the drive force transmitting belt 76 rotates the driven pulley 74 counterclockwise, in the direction indicated by the arrow C2. The drive pulley 72 and the driven pulley 74 are rotated in the same direction and at the same rotational speed.

Therefore, the groove machining unit 24, which is firmly coupled to the driven pulley 74, is rotated counterclockwise about the support bolt 50, in the direction indicated by the arrow C2.

While the groove machining unit 24 is rotated, the robot 12 displaces the machining apparatus 10 vertically downwardly in the direction indicated by the arrow X1.

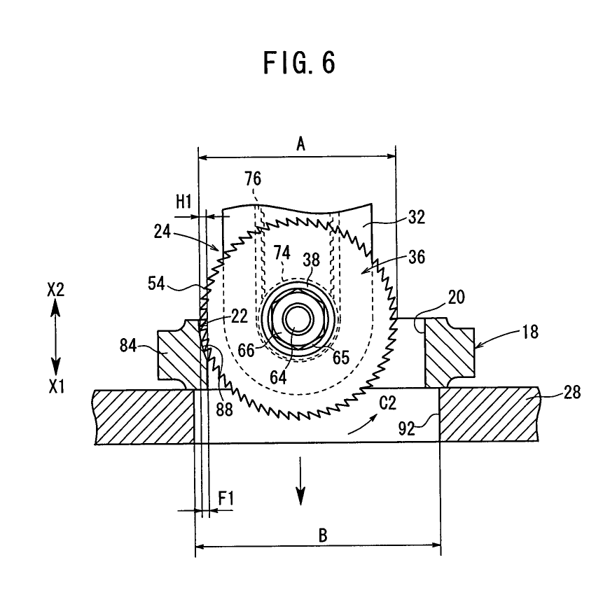

The machining apparatus 10 is gradually displaced vertically downwardly, in the direction indicated by the arrow X1, thereby gradually inserting the groove machining unit 24 into the larger end hole 20 (see FIG. 6). At this time, the outer circumferential surface of the metal saw 36 overlaps the inner circumferential surface of the larger end hole 20 by the overlapping distance F1, radially outwardly from the larger end hole 20. Therefore, the metal saw 36 is displaced downwardly, while contacting and cutting the inner circumferential surface of the larger end hole 20 upon rotation of the groove machining unit 24. Specifically, the metal saw 36 is gradually displaced downwardly while the outer circumferential surface of the metal saw 36 cuts the inner circumferential surface of the larger end portion 84 (see FIG. 7).

The metal saw 36, while it rotates, is displaced downwardly in the direction indicated by the arrow X1, substantially perpendicularly to the upper surface of the mount base 28, thereby forming the first groove 88 having a substantially uniform depth on the inner circumferential surface of the larger end hole 20 of the connecting rod 18. The first groove 88 functions as one of the pair of cracking grooves 22, wherein the first groove 88 is formed linearly in a direction substantially perpendicular to the axis D of the connecting rod 18. The first groove 88 has a substantially V-shaped cross section formed by the cutting teeth 54, which have a cross-sectional shape having a sharp angle (see FIG. 9).

After the first groove 88 has been formed on the inner circumferential surface of the larger end hole 20 of the connecting rod 18, the groove machining unit 24 passes through the larger end hole 20 into a clearance hole 92 defined centrally within the mount base 28, and the groove machining unit 24 is positioned below the connecting rod 18 (see FIG. 7). The clearance hole 92 is greater in diameter than the larger end hole 20, so that the metal saw 36 does not contact the mount base 28 when the groove machining unit 24 is placed within the clearance hole 92.

At this time, the groove machining unit 24 is still rotated counterclockwise by the rotary drive source 68, in the direction indicated by the arrow C2.

Thereafter, the second groove 90 is formed in the larger end hole 20 of the connecting rod 18, at a position that is in a symmetrical relation to the first groove 88, with respect to the axis D of the connecting rod 18 (see FIG. 5).

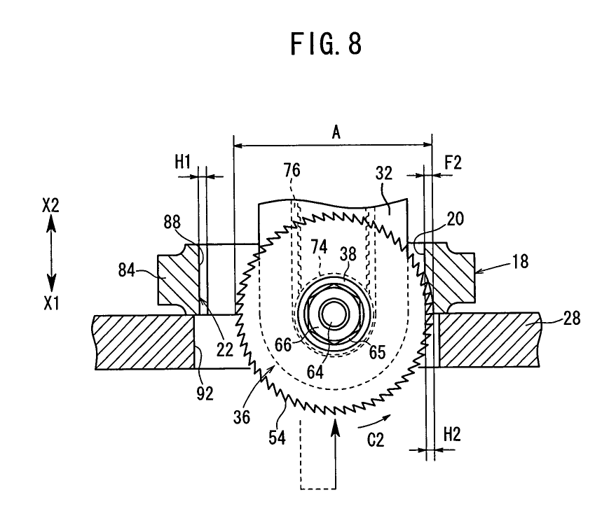

First, as shown in FIG. 7, the machining apparatus 10, which is disposed below the connecting rod 18, is moved under the control of the robot 12, substantially horizontally in the direction indicated by the arrow Y, in order to bring the metal saw 36 toward a right side surface of the larger end hole 20 confronting the first groove 88. The metal saw 36 is moved until the outer circumferential surface thereof overlaps the right side surface of the larger end hole 20, by an overlapping distance F2, radially outwardly from the larger end hole 20 (see FIG. 8).

Stated otherwise, the overlapping distance F2, at which the outer circumferential surface of the metal saw 36 overlaps the inner circumferential surface of the larger end hole 20 radially outwardly of the larger end hole 20, represents and determines the depth H2 (see FIGS. 8 and 9) of the second groove 90, which is formed by the metal saw 36. The overlapping distance F2 is substantially the same as the overlapping distance F1 at which the metal saw 36 overlaps the left side surface of the larger end hole 20 when forming the first groove 88 (F1≅F2). As a result, the depths of the first and second grooves 88, 90 in the larger end hole 20 are substantially the same (H1≅H2).

As shown in FIG. 7, after the metal saw 36 has formed the first groove 88 and then been displaced downwardly of the connecting rod 18, the machining apparatus 10 is moved in a substantially horizontal direction only, in the direction indicated by the arrow Y. Stated otherwise, since the groove machining unit 24 is displaced along the base line E (see FIG. 5) of the larger end hole 20, the machining apparatus 10 is moved to a position which is located across the axis D of the connecting rod 18 from the first groove 88.

After the machining apparatus 10 has been positioned below the larger end hole 20 of the connecting rod 18, the robot 12 gradually displaces the machining apparatus 10 vertically upwardly, in the direction indicated by the arrow X2, thereby gradually inserting the groove machining unit 24 into the larger end hole 20 from a position below the larger end hole 20. The metal saw 36 is displaced upwardly while contacting and cutting the inner circumferential surface of the larger end hole 20, upon rotation of the groove machining unit 24. More specifically, the metal saw 36 is gradually displaced upwardly while the outer circumferential surface of the metal saw 36 cuts the inner circumferential surface of the larger end portion 84 (see FIG. 8).

The metal saw 36, as it rotates, is displaced substantially upwardly in the vertical direction, as indicated by the arrow X2, thereby forming the second groove 90, having a depth which is essentially the same as that of the first groove 88, on the inner circumferential surface of the larger end hole 20 of the connecting rod 18.

As shown in FIG. 5, the second groove 90 is formed on the inner circumferential surface of the larger end hole 20, at a position that is in a symmetrical relationship to the first groove 88 with respect to the axis D of the connecting rod 18. In addition, the second groove 90 has a depth, which is essentially the same as that of the first groove 88 (H1≅H2) (see FIG. 8). The second groove 90 functions as another one of the pair of cracking grooves 22, and is formed linearly in a direction substantially perpendicular to the axis D of the connecting rod 18. The second groove 90 has a substantially V-shaped cross section formed by the cutting teeth 54, which have a cross-sectional shape having a sharp angle (see FIG. 9).

Specifically, as shown in FIG. 9, each of the cracking grooves 22 comprises a pair of straight portions 93 extending substantially in parallel to each other for a predetermined distance from the opening thereof along the inner circumferential surface of the larger end hole 20, and radially outwardly of the larger end hole 20. Each of the cracking grooves 22 also includes a pair of tapered surfaces 94a, 94b contiguous to the straight portions 93 and slanted at predetermined angles in directions toward each other, and an arcuate portion 96 joining crossing portions of the tapered surfaces 94a, 94b.

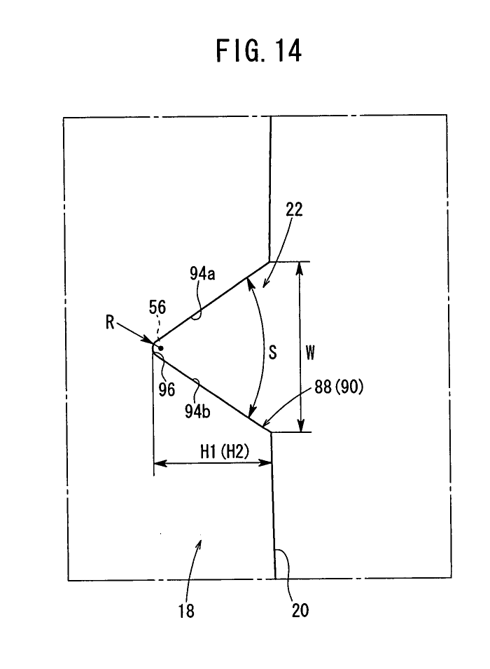

The tapered surfaces 94a, 94b are slanted substantially at the same angle with respect to a central line of the cracking groove 22. As shown in FIG. 14, the cracking groove 22 may also be free of the straight portions 93, in which a pair of tapered surfaces 94a, 94b are provided, slanted from the opening thereof along the inner circumferential surface of the larger end hole 20, at predetermined angles in directions toward each other radially outwardly of the larger end hole 20.

Stated otherwise, the cracking groove 22 is shaped such that the width W (see FIG. 9) of the opening of the cracking groove 22 is determined based on the thickness of the cutting teeth 54 of the metal saw 36, and the radius R (see FIG. 9) of curvature of the arcuate portion 96 is determined based on the radius of curvature of the R portion 56 of the cutting teeth 54.

When the cracking groove 22 has the straight portions 93, the depth of the groove is increased, cutting resistance is reduced, and stresses can be concentrated when the connecting rod is cracked.

Finally, after the groove machining unit 24 passes upwardly through the larger end hole 20, the groove machining unit 24 is placed once again in the initial position above the connecting rod 18 (see FIG. 2). As a consequence, cracking grooves 22 are formed as first and second grooves 88, 90 in the inner circumferential surface of the larger end hole 20 of the connecting rod 18 that is fixed to the upper surface of the mount base 28. Further, the cracking grooves 22 are in a symmetrical configuration with respect to the axis D of the connecting rod D, with their positions and depths being substantially the same as each other.

As shown in FIG. 9, a cracking groove 22 for optimum fracture promotion may be formed such that the width W of the opening along the inner circumferential surface of the larger end hole 20 is in the range of from 0.05 to 1 mm (0.05≦W≦1), and the groove depths H1, H2 from the opening to the arcuate portion 96 are in the range of from 0.1 to 2 mm (0.1≦H1, H2≦2).

If the width W is in excess of 1 mm (W>1), then sufficient stresses required for separating the connecting rod 18 cannot be concentrated on the cracking groove 22, lowering the fracturability of the connecting rod 18 starting from the cracking groove 22. Conversely, if the width W is smaller than 0.05 mm (W<0.05), then burrs produced when the inner circumferential surface of the larger end hole 20 is finished enter into the cracking groove 22, and it is difficult to remove such burrs.

If the groove depths H1, H2 are smaller than 0.1 mm (H2, H2<0.1), then the surface roughness of the fractured surfaces, which are created when the connecting rod 18 is fractured, increases (i.e., the fractured surfaces become rougher), making it difficult to join the separated rod part 20a and the cap part 20b again to each other. Further, because of limitations posed when the connecting rod 18 is manufactured, the groove depths H1, H2 cannot be in excess of 2 mm (H1, H2>2).

The cracking groove 22 may be formed such that an angle S of inclination (see FIG. 9), set as the angle between the tapered surface 94a and the other tapered surface 94b, is in a range of from 20 to 45° (20°≦S≦45°), and the radius R of curvature of the arcuate portion 96 is equal to or less than 0.4 mm (R≦0.4).

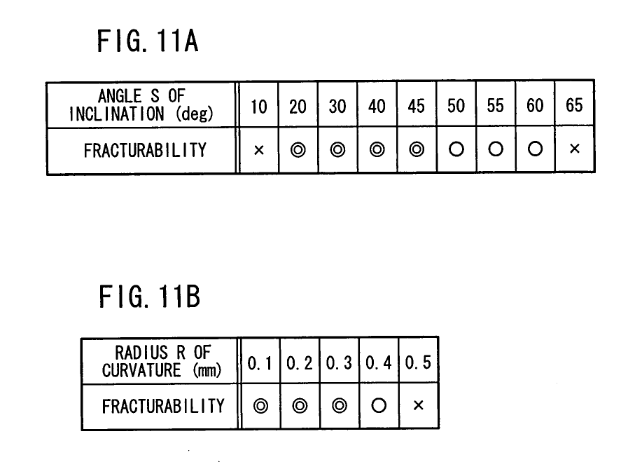

When the angle S of inclination between the tapered surfaces 94a, 94b varies, as shown in FIG. 11A, the fracturability of the connecting rod 18, as it starts to be separated from the cracking groove 22, also varies. Specifically, when the angle S of inclination is in excess of 60° (S>60°), the fracturability of the connecting rod 18, as the connecting rod 18 starts to be separated from the cracking groove 22 having a substantially V-shaped cross section, is low and inadequate (see the mark x in FIG. 11A). When the angle S of inclination is 60° or smaller (S≦60°), since the tip of the cracking groove 22 has a sharp angle, which concentrates stresses thereon at the time the connecting rod 18 is fractured, the fracturability of the connecting rod 18 is good (see the mark ◯ in FIG. 11A). When the angle S of inclination is 45° or smaller (S≦45°), the fracturability of the connecting rod 18 is optimum (see the mark ⊙ in FIG. 11A). When the angle S of inclination is smaller than 20° (S<20°), e.g., when it is 10°, the cutting tool produces problems during the manufacturing process, and hence the fracturability of the connecting rod 18 becomes inadequate.

When the radius R of curvature of the arcuate portion 96 of the cracking groove 22 varies, as shown in FIG. 11B, the fracturability of the connecting rod 18, as it starts to be separated from the cracking groove 22, also varies as discussed below.

Specifically, when the radius R of curvature is in excess of 0.4 mm (R>0.4), since the arcuate portion 96 on the tip of the cracking groove 22 is too large to concentrate stresses on the arcuate portion 96, the fracturability of the connecting rod 18, as it starts to be separated from the cracking groove 22, is low and inadequate (see the mark x in FIG. 11B). When the radius R of curvature of the cracking groove 22 is 0.4 mm or smaller (R≦0.4), since the tip of the cracking groove 22 has a sharp angle, the fracturability of the connecting rod 18 is good (see the mark ◯ in FIG. 11B). When the radius R of curvature is smaller than 0.4 mm (R<0.4), the fracturability of the connecting rod 18 is optimum (see the mark ⊙ in FIG. 11B).

As described above, to produce a cracking groove 22 for optimum fracture promotion, the width W of the groove, which extends radially outwardly from the opening of the larger end hole 20 along substantially parallel walls, is in the range of from 0.05 to 1 mm. Further, the angle S of inclination of the tapered surfaces, which are slanted from the substantially parallel walls radially outwardly toward each other, is in the range of from 20 to 45°. The groove depths H1, H2 from the larger end hole 20 is in the range of from 0.1 to 2 mm. In addition, the radius R of curvature of the arcuate portion 96 disposed between the tapered surfaces 94a, 94b is equal to or less than 0.4 mm.

According to the present embodiment, as described above, the groove machining unit 24, for forming the first groove 88 and the second groove 90 on the inner circumferential surface of the larger end hole 20 of the connecting rod 18, is rotated by the drive force transmitting belt 76 upon rotation of the rotary drive source 68. The metal saw 36 of the groove machining unit 24 is inserted into the inner circumferential surface of the larger end hole 20, and the cutting teeth 54 of the metal saw 36 form a pair of first and second grooves 88, 90, which act as cracking grooves 22, having a substantially V-shaped cross section designed for optimum fracture promotion on the inner circumferential surface of the larger end hole 20.

Therefore, a fracturing jig or the like, not shown, can be inserted into the larger end hole 20 of the connecting rod 18, having the first groove 88 and the second groove 90 formed therein, and can be pressed radially outwardly against the inner circumferential surface of the larger end hole 20, so as to reliably control the first groove 88 and the second groove 90 as fracture starting points, and to thereby fracture the connecting rod 18 reliably and highly accurately into the rod part 20a and the cap part 20b (see FIG. 10B). At this time, the connecting rod 18 can be separated reliably and highly accurately from the cracking grooves 22 by the fracturing jig, under a lower pressure than has heretofore been used.

If the robot 12 for moving the machining apparatus 10 comprises a numerically controlled machine, for example, then the positions to which the machining apparatus 10 is moved can be controlled highly accurately by programming the robot 12. Consequently, the positions and depths of the first groove 88 and the second groove 90 in the larger end hole 20 can be set simply and highly accurately in order to form the first groove 88 and the second groove 90. As a result, the first groove 88 and the second groove 90 can be formed in symmetrical positions with respect to the axis D of the connecting rod 18, at substantially uniform depths in the larger end hole 20.

Furthermore, the groove machining unit 24 includes a metal saw 36, for forming cracking grooves 22 in the larger end hole 20. The metal saw 36 employed in the groove machining unit 24 makes it possible to reduce the size of the R portion 56 on the tip of each of the cutting teeth 54 of the metal saw 36. This allows the arcuate portion 96 of the cracking groove 22 to be cut to a small size, by means of the R portion 56 of the cutting teeth 54, thereby increasing fracturability of the connecting rod 18 as it starts to be separated from the cracking groove 22.

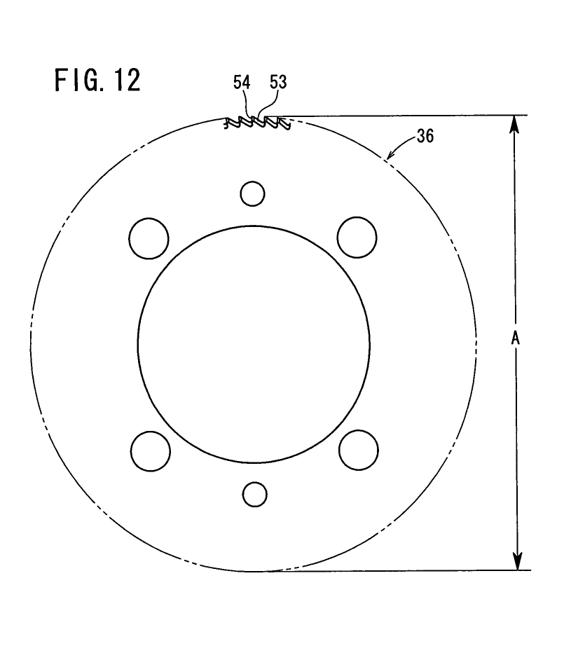

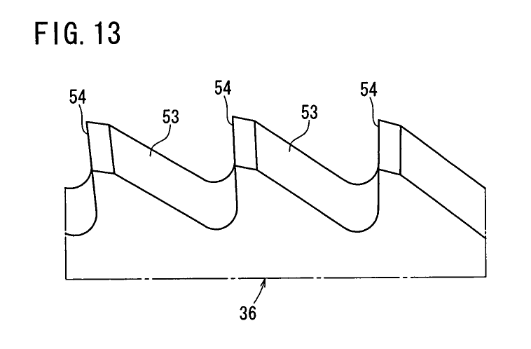

As shown in FIGS. 12 and 13, a double angle milling cutter, having cutting teeth 54 disposed at substantially equal angular intervals along an outer peripheral edge thereof, with chip discharging gaps 53 therebetween, is suitable for use as the metal saw 36. When the cutting teeth 54 contact and cut the inner circumferential surface of the larger end hole 20, the cutting teeth 54 can be brought into successive contact with the inner circumferential surface.

Consequently, impacts and vibrations applied to the spindle 34 can be reduced, as compared with a conventional machining process that uses a tip having intermittent cutting edges, resulting in an increase in durability of the first and second bearings 40, 42 that support the spindle 34. If a double angle milling cutter is used, then such a cutter is effective to reduce the radius R of curvature of the arcuate portion 96 of the cracking grooves 22. The number of cutting teeth of the double angle milling cutter may be established to satisfy the following relationship:
A/10≦the number of cutting teeth≦2A
   where A represents the outer circumferential diameter (maximum outside diameter) of the double angle milling cutter, including the tooth tips thereof. In the above relationship, A/10 indicates a limit for successive contact of the cutting teeth (tooth tips), and 2A indicates a general manufacturing process limitation for the double angle milling cutter.

In addition, installation costs can be reduced, as compared with a conventional broaching process or laser beam machining process, for forming grooves in the larger end hole 20.

According to the present embodiment, cracking grooves 22 formed for optimum fracture promotion are effective in reducing the fracturing load applied in order to fracture the connecting rod 18 into the cap part 20b and the rod part 20a, and also are effective in fracturing the connecting rod 18 with optimum fractured surfaces from optimum regions. Therefore, the cap part 20b and the rod part 20a, once they have been separated, can reliably be temporarily connected again in a subsequent process.

Since the cracking grooves 22 are formed using a metal saw 36, the machining process can be performed employing an inexpensive machining facility, and the cracking grooves 22 can be formed accurately to a shape having the same level and quality as is possible using a laser beam machining process. As a consequence, according to the present embodiment, the shape of the cracking grooves 22 can be controlled accurately in order to easily provide a groove configuration that is optimum for fracture promotion.

1. An apparatus for machining a pair of cracking grooves in a one-piece connecting rod having a larger end portion and a smaller end portion, at respective facing positions on an inner circumferential surface of a larger end hole in said larger end portion, for fracturing said connecting rod into a rod part and a cap part, said apparatus comprising:
a body;
a rotary drive source coupled to said body;
a groove machining unit comprising a metal saw having a plurality of serrated sharp cutting teeth disposed on a peripheral edge thereof successively along a circumferential direction thereof, said cutting teeth projecting radially outwardly, and a rotary cutting mechanism on which said metal saw is rotatably supported pivotally; and
a drive power transmitting mechanism for transmitting rotational drive power from said rotary drive source to said rotary cutting mechanism,
wherein when said rotary drive source is energized, said rotary cutting mechanism is rotated by said drive power transmitting mechanism, and said rotary cutting mechanism is displaced toward said larger end hole, thereby causing said metal saw to form a pair of cracking grooves having a substantially V-shaped cross section on the inner circumferential surface of the larger end hole of said connecting rod.

2. An apparatus according to claim 1, wherein a drive shaft of said rotary drive source, and a rotational shaft on which said metal saw is rotatably supported, extend substantially parallel to an axis of said connecting rod.

3. An apparatus according to claim 1, wherein said drive power transmitting mechanism comprises a drive pulley coupled to said drive shaft of said rotary drive source, a driven pulley spaced a predetermined distance from said drive pulley and coupled to said groove machining unit, and a belt trained around said drive pulley and said driven pulley.

4. An apparatus according to claim 1, wherein said groove machining unit comprises a support coupled to said body, a spindle rotatably held by said support, wherein said metal saw is fitted over said spindle for rotation in unison therewith, and a spacer and a nut sandwiching said metal saw against said spindle.

5. An apparatus according to claim 1, wherein said metal saw comprises a double angle milling cutter having cutting teeth disposed at substantially equal angular intervals along an outer peripheral edge portion thereof, with chip discharging gaps therebetween.

6. An apparatus according to claim 5, wherein the number of cutting teeth of said double angle milling cutter is established to satisfy the following relationship:
A/10≦the number of cutting teeth≦2A
where A represents the outside diameter of the double angle milling cutter including tooth tips.

7. A method of machining a pair of cracking grooves in a one-piece connecting rod having a larger end portion and a smaller end portion, at respective facing positions on an inner circumferential surface of a larger end hole in said larger end portion, for fracturing said connecting rod into a rod part and a cap part, wherein:
a width (W) of a groove extending as each of said cracking grooves radially outwardly from an opening of said larger end hole along substantially parallel walls is in a range of from 0.05 to 1 mm,
an angle (S) of inclination of a pair of tapered surfaces slanted from said substantially parallel walls radially outwardly toward each other is in a range of from 20 to 45°, and
a depth (H1, H2) of the groove from said larger end hole is in a range of from 0.1 to 2 mm.

8. A method according to claim 7, wherein each of said cracking grooves includes an arcuate portion disposed between said tapered surfaces, wherein a radius (R) of curvature of said arcuate portion is equal to or less than 0.4 mm.
